(19) United States
(12) Patent Application Publication
(10) Pub. No.: US 2008/0065601 A1
(43) Pub. Date: Mar. 13, 2008

(54) System for disseminating product information

(76) Inventor: Jon Korbonski, Irvine, CA (US)

Correspondence Address: Jon Korbonski, 21 Morgan, Irvine, CA, 92618, US

(21) Appl. No.: 11/520,513

(22) Filed: Sep. 12, 2006

(51) Int. Cl. G06F 17/30

(52) U.S. Cl. 707/3

(57) ABSTRACT

A product information dissemination system comprising at least one computer associated in physical proximity to a product, said computer having a database with product information and further having a user interface for accessing product information from the server and database.

### FIELD OF THE INVENTION

The present invention is directed to the field of dissemination of product information. In particular, the present invention is described as a portable touch screen device, which can be used and/or adapted for use on a sales floor or showroom floor, such as a car agency.

### BACKGROUND OF THE INVENTION

There have been a number of patents directed to the field of portable touch screen PC's. PC's and kiosks have been used for applications related to product dissemination. With the growth of the Internet and mega discounters such as Walmart and Best Buy, retailers have been under tremendous pressure to watch the bottom line. The most frequent area of cost cutting has been in the number and quality of sales personnel. This has come at a time when the level of product sophistication is changing faster than ever. The level of sales people working in the automotive and retail industries has become lower due to the pay being lower. As new products come out, the sales people are unable to learn all of the information and are therefore often unable to answer questions that are asked by customers. Further, due to bottom line pressures, particularly in the automotive industry, many people have experienced the feeling of being attacked by sales people as soon as they walk onto a lot.

There are prior art patents which relate to this field. U.S. Pat. No. 6,941,130 to Kimura discloses an information providing apparatus comprising a computer program and an information providing method. The method includes an information providing a sequence setting for automatically setting the sequence in which the information is provided, a traveling status discriminating for discriminating a traveling speed of a vehicle, an information providing initiation discriminating section for discriminating initiation in which the information is provided to the vehicle occupant, and an information providing mode change-over section for executing change-over between a first information providing mode to permit the information to be provided in a sequence set with an input unit and a second information providing mode to permit the information to be provided in a sequence set with the information providing sequence setting section 4a, based on resulting discrimination of the traveling status discriminating when the information providing initiation discriminating section discriminates an initiation in which the information is provided.

U.S. Pat. No. 5,663,746 to Pellenberg discloses an interactive information kiosk assembly for use by automotive dealerships, or the like, to inform potential customers about the exterior paint colors and the colors and materials for upholstery and trim available for selected model automobiles. The interactive information kiosk assembly has a series of turntable assemblies having a series of color and material swatches that are indicative of the color and material choices available for the exterior paint, upholstery and trim of selected model automobiles. The turntable assemblies are rotatable about a vertical axis extending through the kiosk assembly to enable the customer to mix and match varying exterior paint colors with various upholstery and trim materials and colors. An interactive video display monitor is provided for displaying a video image of a selected model automobile having a selected combination of exterior paint, upholstery and trim colors and materials.

Kiosks, such as disclosed in the Pellenberg patent, are large and centralized. There is a long felt need to provide a computer based system for providing product information which can easily be disseminated and which can be more widely distributed.

It is a principal object of the invention to provide a widely distributed product information system which can be used to provide a variety of buyers with product information.

It is a further object of the present invention to provide a system in which product information is disseminated by devices such as tablet computers.

### SUMMARY OF THE INVENTION

In accordance, the invention is a product information dissemination system comprising at least one computer associated in physical proximity to a product, said computer having a database with product information and further having a user interface for accessing product information from the server and database.

In a further embodiment, the invention is a product information dissemination system comprising a central server, a database and wireless communication system, said database storing information regarding a plurality of products to be sold and at least one computer associated in physical proximity to a product, said computer having wireless access to the database and server, and further having a user interface for accessing product information from the server and the database.

In yet a further embodiment, the invention is a product information dissemination system comprising a central server, a database and wireless communication system, said database storing information regarding a plurality of products to be sold and at least one portable computer associated in physical proximity to a product having wireless access to the database and server, said portable computer having a user interface for accessing product pricing, and consumer information from the server and database.

In a still yet further embodiment, the invention is a product information dissemination system comprising a central server, a database and wireless communication system, said database storing information regarding a plurality of products and at least one computer associated in physical proximity to a product to be sold, having wireless access to the database and server, said tablet computer having a user interface for accessing product information from the computer or from the server and database.

### DESCRIPTION OF THE FIGURES

FIG. 1 is a block diagram of the present invention in an automotive showroom.

FIG. 2 is a user screen which may be used in a showroom illustrating pricing in accordance with the invention.

FIG. 3 is a subscreen for pricing.

FIG. 4 illustrates an alternative embodiment of the invention.

FIG. 5 is an exemplary user screen in accordance with an alternative embodiment invention.

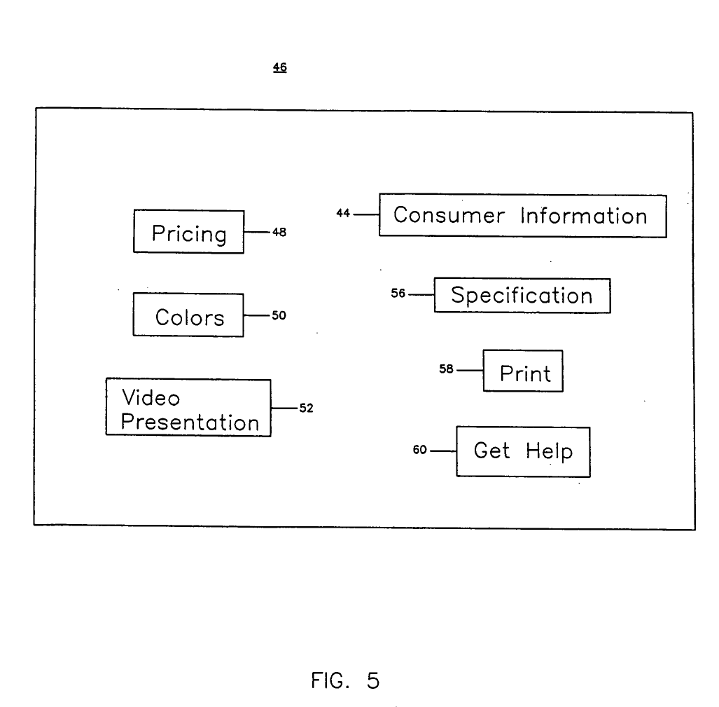

### DESCRIPTION OF THE PREFERRED EMBODIMENT

The present invention is described with reference to the enclosed Figures wherein the same numbers are used where applicable. In a most preferred embodiment, the invention comprises product information which an end user customer can access information regarding a major item such as a television, automobile, washer/dryer, or other major appliance. The device may have pre-stored presentations on information which relates to the product or have wireless access to a server.

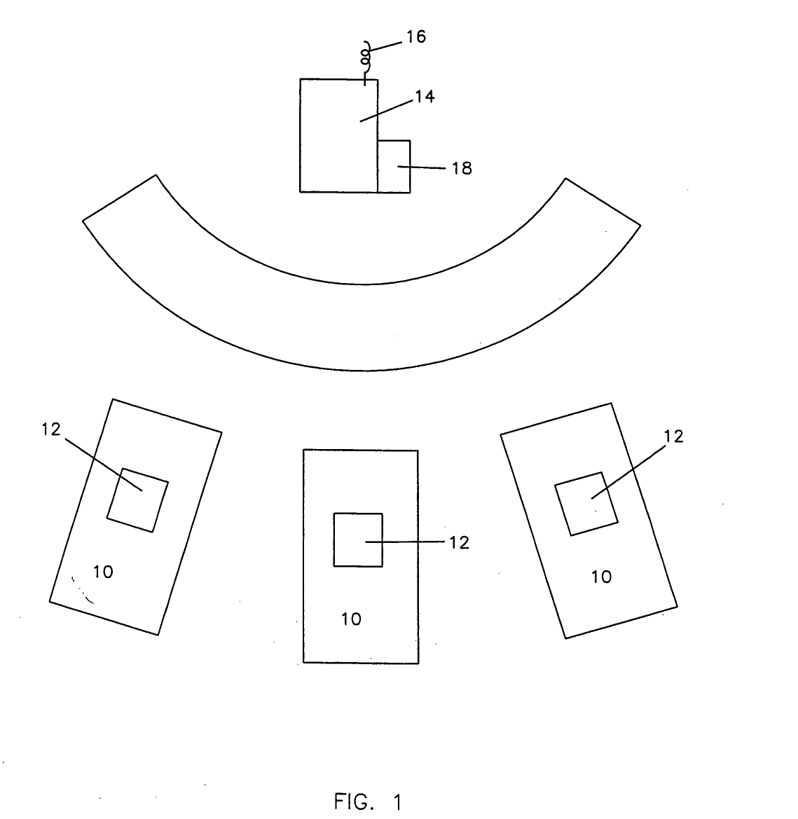

As shown in FIG. 1, the invention may be utilized in the context of an automotive showroom. The system will comprise a server 14, database 18 and wireless transmitter 16 which may be centrally housed at the venue. The second part of the system comprises of one or more tablet computer or similar stations 12 which are near or affixed to a vehicle 10. For example, the unit can be attached to the inside of a windshield in a car on the showroom floor. The tablet computers 12 will have information stored therein and will also further have wireless internet access to the server 14 and to the internet 14.

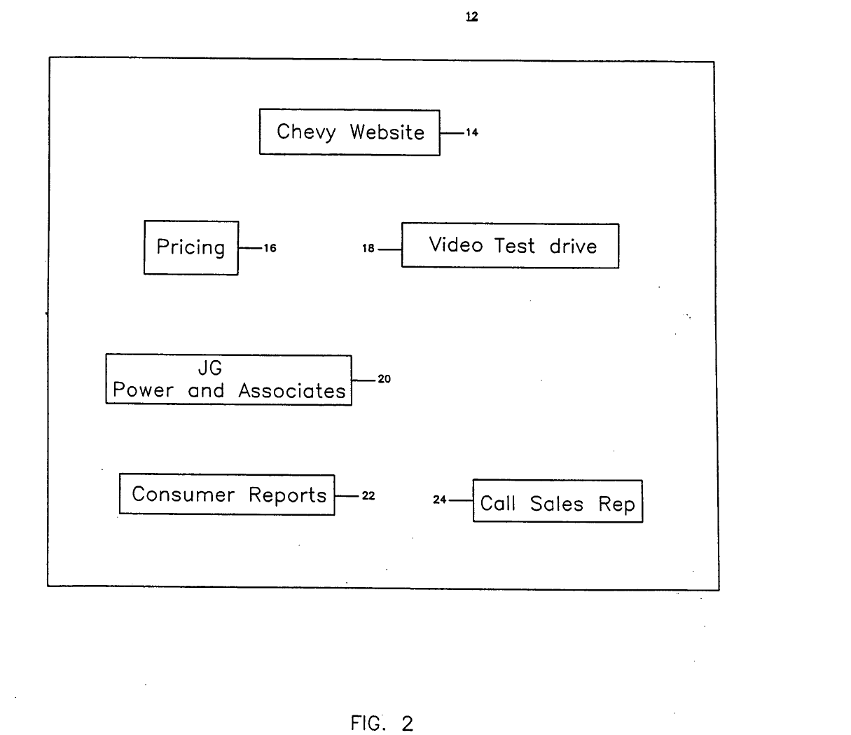

As shown in FIG. 2, the tablet computer will have a user interface which will provide internet access 15, pricing information 16, a video test drive 18, consumer and technical information 20,22, and the ability to contact a sales representative 24.

It is to be appreciated that in a most basic embodiment that the central server can be completely omitted. The tablet 12 can be pre-coded with all relevant information, presentations and data and have wireless internet access.

For the car dealership or store, this invention will allow the venue to provide better sales information that provides for completely controlled content. The dealer or store can also manage its sales force better and increase efficiency on the sales floor. In some cases, this unit will allow the dealer or store to reduce the sales force because it does not have sales personnel needlessly following customers around.

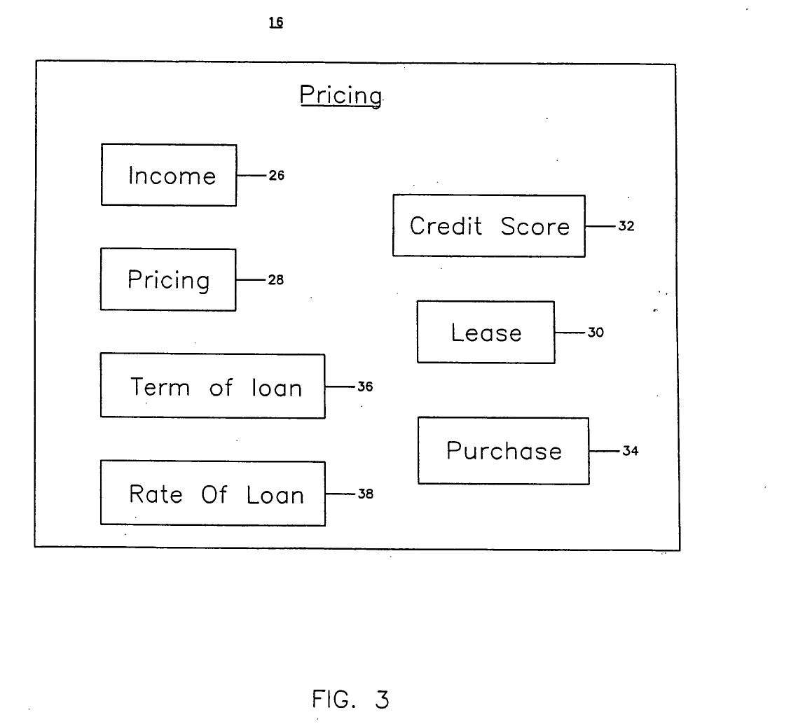

An exemplary pricing screen 16 is shown in FIG. 3. The screen provides a place for the customer to place his/her income 26, pricing of the desired product or vehicle 28, a term of a loan 36, rate of a loan 38, credit score input and option to lease or purchase 34 the vehicle. The tablet computer's close proximity to the vehicle makes it easier for the customer to make decisions on location.

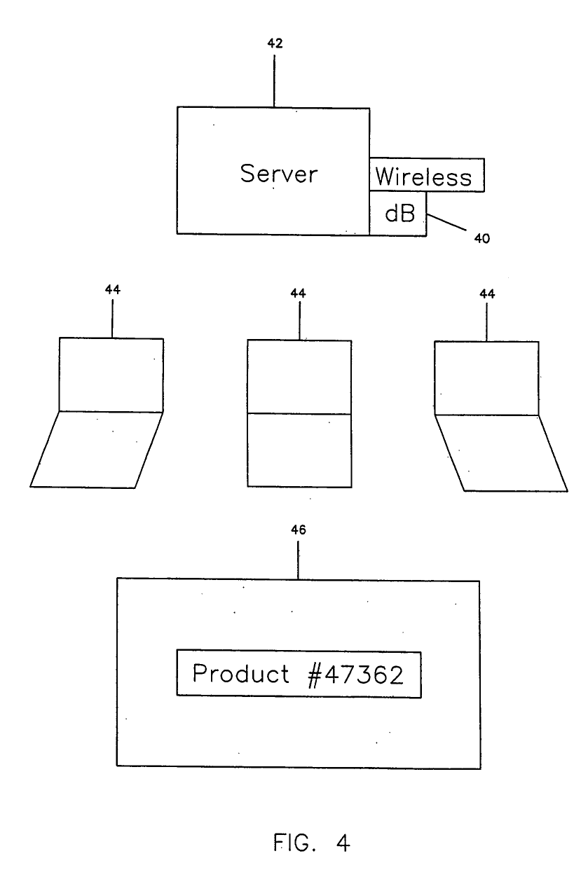

FIG. 4 illustrates an embodiment of the invention in which the tablets 44 can be moved and carried about by customers. In this version, the system will be placed in a store such as an appliance store. The store will have servers 42, a database 40 and a wireless interface 41. The tablet computers can be accessed by the customers and freely moved around the store.

In this example, the end user may take the tablet computer 12 from a central location (e.g. a bin) and freely move about the store. The customer may find a product, (e.g. a dishwasher), that he/she is interested in, and input the product code 46 such as “47362” appearing on the product into the tablet. This will access a second screen which provides access to pricing information 48, color choices 50, a video presentation 52, consumer reports 44, product specifications 56, a print option 58 and a help button 60.

If the customer desires to speak to a sales associate, he/she may press the help button 60, which will signal the sales person to approach the customer. The invention allows the product to be a part of the sales process and eliminate the need for a sales associate until the customer is ready. Since the device is portable and can be easily loaded with information, the units can be moved around to different locations in a venue. The present invention can be used, for example, in a department store.

The unit can be moved from the stereo section to the appliances section. More units can be grouped in the section they are experiencing trouble with or toward special events. If the store is having an appliance sale for just one weekend, for example, the store can move all of their units in and have programs for the sale items just for a few days. This will allow them to buy fewer units versus dedicated kiosks. Manufacturers may pay for the unit to be dedicated to their products on a showroom floor.

A sensor feature can be used to extend the battery life of a portable unit if the unit is being run off of internal batteries. The unit can hibernate until someone is standing in the right position.

The present invention suggests a number of attractive embodiments. For example, customers may be able to bring their laptops, Blackberrys or PDAs to a venue and then access the system via the internet.

The present invention has been described with reference to the above discussed preferred embodiment. The true nature and scope of the invention is to be determined with reference to the attached claims.

1. A product information dissemination system comprising:
at least one computer associated in physical proximity to a product,
said computer having a database with product information and further having a user interface for accessing product information from the server and database.

2. A product information dissemination system comprising:
a central server, a database and wireless communication system,
said database storing information regarding a plurality of products to be sold; and
at least one computer associated in physical proximity to a product,
said computer having wireless access to the database and server, and further having a user interface for accessing product information from the server and database.

3. A product information dissemination system comprising:
a central server, a database and wireless communication system,
said database storing information regarding a plurality of products to be sold; and
at least one portable computer associated in physical proximity to a product, having wireless access to the database and server,
said portable computer having a user interface for accessing product pricing and consumer information from the server and database.

4. A product information dissemination system comprising:
a central server, a database and wireless communication system,
said database storing information regarding a plurality of products; and
at least one computer associated in physical proximity to a product to be sold, having wireless access to the database and server,
said tablet computer having a user interface for accessing product information from the computer or from the server and database.
